(19) United States
(12) Patent Application Publication
(10) Pub. No.: US 2025/0203635 A1
(43) Pub. Date: Jun. 19, 2025

(54) METHODS AND APPARATUSES FOR SIDELINK TRANSMISSION

(71) Applicant: LENOVO (BEIJING) LIMITED, Beijing (CN)

(72) Inventors: Zhennian SUN, Beijing (CN); Haipeng LEI, Beijing (CN); Xiaodong YU, Beijing (CN); Xin GUO, Beijing (CN)

(21) Appl. No.: 18/847,781

(22) PCT Filed: Mar. 18, 2022
(86) PCT No.: PCT/CN2022/081661

§ 371 Date: Sep. 17, 2024

(51) Int. Cl. H04W 72/25; H04W 72/02

(52) U.S. Cl. CPC H04W 72/25; H04W 72/02

(57) ABSTRACT

The present application relates to methods and apparatuses for sidelink transmission. An embodiment of the present disclosure provides a user equipment (UE), which may include a transceiver; and a processor coupled to the transceiver. The processor may be configured to: select at least one resource on at least one carrier of a plurality of carriers; determine that a simultaneous transmission of a first transmission on a first resource on a first carrier of the plurality of carriers and at least one transmission on the at least one resource is not supported by a transmit capability of the UE, wherein the first carrier is different from the at least one carrier; and transmit assistant information associated with the first resource to another UE.

### TECHNICAL FIELD

The present disclosure relates to sidelink transmission, and more specifically relates to methods and apparatuses for sidelink transmission with limited transmit (Tx) capability of a user equipment (UE).

### BACKGROUND OF THE INVENTION

Sidelink carrier aggression (CA) may include inter-band CA or intra-band CA. A UE may perform simultaneous transmissions on multiple carriers. However, the Tx capability of the UE may be limited, which renders that some simultaneous transmissions may not be performed.

The present disclosure proposes some solutions for solving the issues that may occur during the simultaneous transmissions on multiple carriers.

### SUMMARY

One embodiment of the present disclosure provides a user equipment (UE), which may include a transceiver; and a processor coupled to the transceiver, wherein the processor is configured to: select at least one resource on at least one carrier of a plurality of carriers; determine that a simultaneous transmission of a first transmission on a first resource on a first carrier of the plurality of carriers and at least one transmission on the at least one resource is not supported by a transmit capability of the UE, wherein the first carrier is different from the at least one carrier; and transmit assistant information associated with the first resource to another UE.

Another embodiment of the present disclosure provides a UE, which may include a transceiver; and a processor coupled to the transceiver, wherein the processor is configured to: determine assistant information associated with a PSFCH transmission on a carrier of a plurality of carriers; and transmit the assistant information to a base station (BS).

Yet another embodiment of the present disclosure provides a method performed by a UE, which may include selecting at least one resource on at least one carrier of a plurality of carriers; determining that a simultaneous transmission of a first transmission on a first resource on a first carrier of the plurality of carriers and at least one transmission on the at least one resource is not supported by a Tx capability of the UE, wherein the first carrier is different from the at least one carrier; and transmitting assistant information associated with the first resource to another UE.

In some embodiments, the first transmission includes a physical sidelink feedback channel (PSFCH) transmission that at least partially overlaps with the at least one resource in a time domain, or at least partially overlaps with a radio frequency (RF) retuning period from a carrier of the at least one carrier to the first carrier.

In some embodiments, a carrier combination of the first carrier and the at least one carrier are not supported.

In some embodiments, the first resource is for a PSFCH transmission.

In some embodiments, the assistant information indicates a slot index of the first resource.

In some embodiments, the assistant information indicates a slot index of a physical sidelink share channel (PSSCH) reception associated the PSFCH transmission on the first resource.

In some embodiments, the Tx capability of the UE may include at least one of: a limited number of simultaneous transmission carriers, a limitation on supported carrier combinations, or an interruption for RF retuning.

Still another embodiment of the present disclosure provides a method performed by a UE which may include determining assistant information associated with a PSFCH transmission on a carrier of a plurality of carriers; and transmitting the assistant information to a BS.

In some embodiments, the PSFCH transmission includes at least one of: a PSFCH transmission associated with a PSSCH reception with enabled hybrid automatic repeat request acknowledgement (HARQ-ACK); a PSFCH transmission associated with a reserved PSSCH reception; or a PSFCH transmission associated with a resource conflict indicator.

In some embodiments, the reserved PSSCH reception is reserved by a PSSCH reception with an enabled HARQ-ACK.

In some embodiments, the PSFCH transmission associated with a resource conflict indicator indicates a resource conflict of a PSSCH transmission.

In some embodiments, the PSFCH transmission associated with a resource conflict indicator indicates a potential resource conflict of a PSSCH transmission based on a channel busy ratio (CBR) measurement associated with the PSSCH transmission.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present disclosure;

FIG. 2 illustrates an exemplary sidelink transmission according to some embodiments of the present disclosure;

FIG. 3 illustrates an exemplary sidelink transmission according to some embodiments of the present disclosure;

FIG. 4 illustrates an exemplary sidelink transmission according to some embodiments of the present disclosure;

FIG. 5 illustrates an exemplary sidelink transmission according to some embodiments of the present disclosure;

FIG. 6 illustrates an exemplary sidelink transmission according to some embodiments of the present disclosure;

FIG. 7 illustrates an exemplary method for wireless communication according to a preferred embodiment of the present disclosure;

FIG. 8 illustrates an exemplary method for wireless communication according to a preferred embodiment of the present disclosure; and

FIG. 9 illustrates a simplified block diagram of an exemplary apparatus according to some embodiments of the present disclosure.

### DETAILED DESCRIPTION

The detailed description of the appended drawings is intended as a description of the currently preferred embodiments of the present disclosure, and is not intended to represent the only form in which the present disclosure may be practiced. It should be understood that the same or equivalent functions may be accomplished by different embodiments that are intended to be encompassed within the spirit and scope of the present disclosure.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

Embodiments of the present disclosure may be provided in a network architecture that adopts various service scenarios, for example but not limited to, 3GPP 3G, LTE, LTE-Advanced (LTE-A), 3GPP 4G, 3GPP 5G NR, 3GPP Release 16 and onwards, etc. It is contemplated that along with the 3GPP and related communication technology development, the terminologies recited in the present disclosure may change, which should not affect the principle of the present disclosure.

Embodiments of the present disclosure may relate to coexistence between LTE V2X and NR V2X. It is contemplated that all embodiments in the present disclosure are also applicable to similar technical problems in coexistence between other different radio access technologies (RATs).

User equipment (UE) under NR V2X scenario and/or LTE V2X scenario may be referred to as V2X UE(s). A V2X UE which transmits data on sidelink may be referred to as a UE for transmitting, a transmitting UE, a transmitting V2X UE, a Tx UE, a V2X Tx UE, a sidelink (SL) Tx UE, or the like. A V2X UE which receives data on sidelink may be referred to as a UE for receiving, a receiving UE, a receiving V2X UE, an Rx UE, a V2X Rx UE, an SL Rx UE, or the like.

V2X UE(s) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like.

According to some embodiments of the present disclosure, V2X UE(s) may include a portable wireless communication device, a smart phone, a cellular telephone, a flip phone, a device having a subscriber identity module, a personal computer, a selective call receiver, or any other device that is capable of sending and receiving communication signals on a wireless network.

According to some embodiments of the present disclosure, V2X UE(s) may include wearable devices, such as smart watches, fitness bands, optical head-mounted displays, or the like. Moreover, V2X UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. V2X UE(s) may communicate directly with BS(s) via communication signals.

A BS under NR V2X scenario and/or LTE V2X scenario may be referred to as a base unit, a base, an access point, an access terminal, a macro cell, a Node-B, an enhanced Node B (eNB), a gNB, a Home Node-B, a relay node, a device, a remote unit, or by any other terminology used in the art. A BS may be distributed over a geographic region. Generally, a BS is a part of a radio access network that may include one or more controllers communicably coupled to one or more corresponding base stations.

ABS is generally communicably coupled to one or more packet core networks (PCN), which may be coupled to other networks, like the packet data network (PDN) (e.g., the Internet) and public switched telephone networks, among other networks. These and other elements of radio access and core networks are not illustrated but are well known generally by those having ordinary skill in the art. For example, one or more BSs may be communicably coupled to a mobility management entity (MME), a serving gateway (SGW), and/or a packet data network gateway (PGW).

A BS may serve a number of V2X UEs within a serving area, for example, a cell or a cell sector via a wireless communication link. A BS may communicate directly with one or more V2X UEs via communication signals. For example, a BS may serve V2X UEs within a macro cell.

Sidelink communication between a Tx UE and a receive (Rx) UE under NR V2X scenario includes groupcast communication, unicast communication, or broadcast communication.

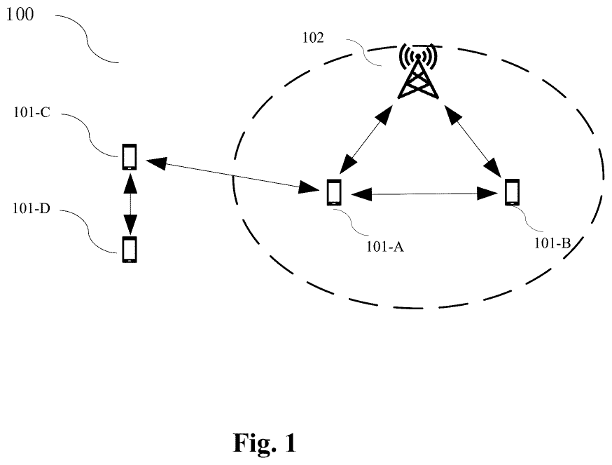

FIG. 1 illustrates an exemplary wireless communication system 100 (e.g., a V2X communication system) in accordance with some embodiments of the present disclosure.

As shown in FIG. 1, the wireless communication system 100 includes a base station (e.g., BS 102), and some UEs (e.g., UE 101-A, UE 101-B, UE 101-C, and UE 101-D). UE 101-A and UE 101-B are within the coverage of BS 102, and UE 101-C and UE 101-D are outside the coverage of BS 102. UE 101-A, UE 101-B, UE 101-C, and UE 101-D may perform sidelink unicast transmission, sidelink groupcast transmission, or sidelink broadcast transmission. UE 101-A, UE 101-B, UE 101-C, and UE 101-D may be referred to as a V2X UE. It is contemplated that, in accordance with some other embodiments of the present disclosure, a V2X communication system may include more BSs and more or fewer V2X UEs.

In addition, although the V2X UEs as shown in FIG. 1 are illustrated in the shape of a cellphone, it is contemplated that a V2X communication system may include any type of UE (e.g., a roadmap device, a cell phone, a computer, a laptop, IoT device or other type of device) in accordance with some other embodiments of the present disclosure.

According to some embodiments of FIG. 1, UE 101-A may function as a Tx UE, and UE 101-B, UE 101-C, and UE 101-D may function as Rx UEs. UE 101-A may exchange V2X messages with UE 101-B or UE 101-C through a sidelink using, for example, the NR technology or the LTE technology, through PC5 interface as defined in 3GPP documents. UE 101-A may transmit information or data to other UE(s) within the V2X communication system through sidelink unicast, sidelink groupcast, or sidelink broadcast. For instance, UE 101-A may transmit data to UE 101-B in a sidelink unicast session. UE 101-A may transmit data to UE 101-B and UE 101-C in a groupcast group by a sidelink groupcast transmission session. Also, UE 101-A may transmit data to UE 101-B and UE 101-C by a sidelink broadcast transmission session.

Alternatively, according to some other embodiments of FIG. 1, UE 101-B or UE 101-C may function as a Tx UE and transmit information or data, and UE 101-A may function as an Rx UE and receive information or data from UE 101-B or UE 101-C.

Both UE 101-A and UE 101-B in the embodiments of FIG. 1 may transmit information to BS 102 and receive control information from BS 102, for example, via a Uu interface. BS 102 may define one or more cells, and each cell may have a coverage area. As shown in FIG. 1, both UE 101-A and UE 101-B are within the coverage of BS 102, while UE 101-C and UE 101-D are not.

The BS 102 as illustrated and shown in FIG. 1 may not be a specific base station, but may be any base station(s) in the V2X communication system. For example, assuming that the V2X communication system includes two BSs, UE 101-A being within a coverage area of any one the two BSs may be called as a case that UE 101-A is within the coverage of a BS in the V2X communication system; and only UE 101-A being outside of coverage area(s) of both BSs can be called as a case that UE 101-A is outside of the coverage of a BS in the V2X communication system.

UEs may operate in different modes. At least the following two sidelink resource allocation modes are defined for sidelink communication: resource allocation mode 1: a BS schedules a sidelink resource(s) to be used by a UE for sidelink transmission(s); and resource allocation mode 2: a UE determines a sidelink transmission resource(s) within sidelink resources configured by a BS or network, or pre-configured sidelink resources. In resource allocation mode 2, a BS does not schedule the sidelink resources for a UE. In FIG. 1, UE 101-A and UE 101-B may be in resource allocation mode 1, and UE 101-C and UE 101-D may be in resource allocation mode 2.

With improved UE capability, a UE may perform sidelink transmission, sidelink reception, or both on different component carriers (CCs). However, the Tx capability of the UE may be limited. In the present disclosure, the UE capability may include at least one of the following:
a) A limited number of simultaneous transmission carriers. For example, a UE may have a limited number of Tx chains, for example, two Tx chains, which means that the UE may perform two simultaneous transmissions on two different carriers.
b) A limitation on supported carrier combination(s) or band combination(s). A UE may not support a given carrier (or band) combination. For example, the UE may support the carrier combination of carrier #1 and carrier #2, but does not support the carrier combination of carrier #1 and carrier #3.
c) An interruption for radio frequency (RF) retuning. The UE may switch a Tx chain from one carrier to another carrier (or one band to another band), but during the switching time, the UE may not perform a data transmission.

In some embodiments of the present disclosure, a UE may perform the PSSCH transmission, the PSFCH transmission for HARQ-ACK feedback, and the PSFCH transmission for a resource conflict indicator. The PSSCH transmission may be predictable at a Tx UE side. However, the PSFCH transmission for HARQ-ACK feedback and the PSFCH transmission for resource a conflict indicator may not be predicable, because they depend on the transmission of another sidelink UE(s).

The present disclosure proposes solutions for a sidelink transmission, especially when a UE with a limited Tx capability performs simultaneous transmissions on multiple carriers. The proposed solutions can at least solve the problem caused by the simultaneous transmissions exceeding the Tx capability of the UE. More details on the embodiments of the present disclosure will be illustrated in the following text in combination with the appended drawings.

In the present disclosure, a UE may perform multiple PSFCH transmissions on resources on different carriers. In some cases, the UE may reach its Tx capability, and cannot perform a PSFCH transmission. In this case, the UE may determine the assistant information which includes, for example, information related to the PSFCH transmission(s) that the UE cannot perform, and inform another UE(s). The assistant information can inform the another UE(s) that the UE prefers not to receive the PSSCH transmission(s) with HARQ-ACK feedback enabled corresponding to the PSFCH transmission(s) due to the limited Tx capability. “HARQ-ACK feedback enabled” means that a UE is supposed to transmit the HARQ-ACK feedback for a PSSCH. For example, the UE needs to perform a PSFCH transmission for the received PSSCH transmission.

In some examples, the assistant information may include the information of the resources for the PSSCHs corresponding to the PSFCH transmissions that the UE cannot perform due to its Tx capability limitation. For example, the assistant information may include the slot indexes of the resources for the PSSCHs. In some examples, the assistant information may include the information of the resources for the PSFCH transmissions that the UE cannot perform due to its Tx capability limitation. For example, the assistant information may include the slot indexes of the resources for the PSFCH transmissions. Although in the embodiments of the present disclosure, a slot index is used in the assistant information to identify a PSFCH resource or a PSSCH resource, it should be understood that other information that can identify the PSFCH resource or the PSSCH resource are also encompassed within the spirit and scope of the present disclosure.

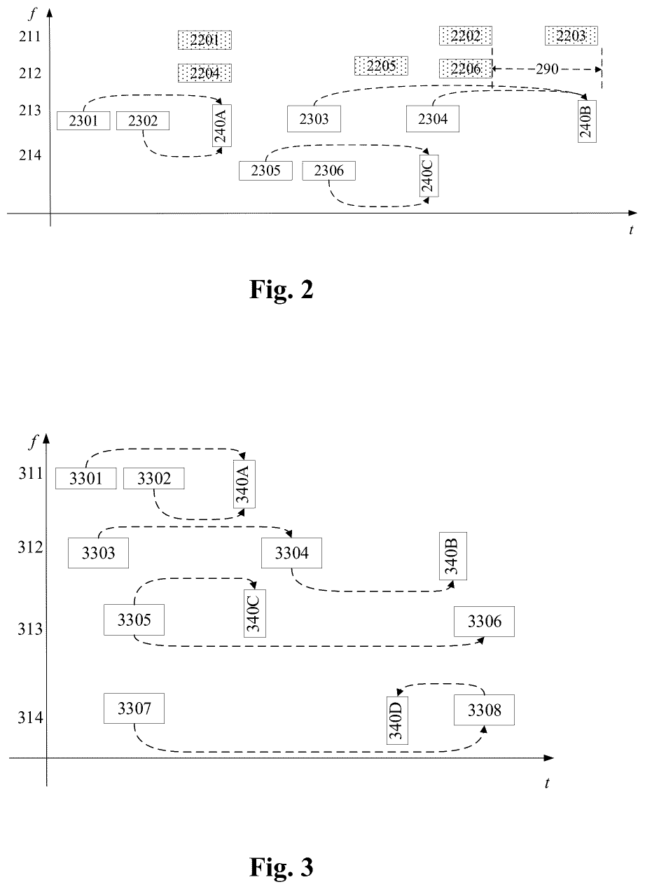

FIG. 2 illustrates an exemplary sidelink transmission according to some embodiments of the present disclosure.

In FIG. 2, a UE may be configured with a plurality of component carriers (CCs), e.g., CC 211, CC 212, CC 213, and CC 214 in a frequency domain (i.e., the vertical axis marked by “f” in FIG. 2). The UE may have selected some resources, e.g., resource 2201, resource 2202, and resource 2203 on CC 211, resource 2204, resource 2205, and resource 2206 on CC 212, which are represented by the blocks with dots.

Hereinafter, the resource for a PSSCH transmission or reception may also be referred to as a PSSCH resource, and the resource for a PSFCH transmission or reception may also be referred to as a PSFCH resource.

Resource 2301 and resource 2302 are PSSCH resources on CC 213, and resource 240A is a PSFCH resource on CC 213. Resource 2301 and resource 2302 may be associated with resource 240A. For example, when the UE receives a PSSCH with HARQ-ACK feedback enabled on resource 2301 or resource 2302, the UE can transmit the corresponding HARQ-ACK feedback (e.g., in a PSFCH transmission) for the PSSCH on resource 240A. Resource 2303 and resource 2304 are PSSCH resources on CC 213, and resource 240B is a PSFCH resource on CC 213. Resource 2303 and resource 2304 may be associated with resource 240B. Resource 2305 and resource 2306 are PSSCH resources on CC 214, and resource 240C is a PSFCH resource on CC 214. Resource 2305 and resource 2306 may be associated with resource 240C.

As can be seen, in a time domain (i.e., the horizontal axis marked by “t” in FIG. 2), resource 240A on CC 213 overlaps resource 2201 on CC 211 and resource 2204 on CC 212. Since the UE has selected resource 2201 and resource 2204, assuming that supporting the simultaneous transmission on resource 2201 and resource 2204 has reached the Tx capability of the UE, the UE would prefer not to perform the PSFCH transmission on resource 240A. In this case, the UE may transmit the assistant information, which may include the slot index of the PSFCH resource, e.g., the slot index of resource 240A. Alternatively, the assistant information may include the slot indexes of the PSSCH resources that are associated with the PSFCH resource 240A, that is, the slot index of resource 2301 and the slot index of resource 2302.

In some examples, assuming that the Tx capability of the UE does not support the carrier combination of CC 212 and CC 214, since the UE has selected resource 2205, and the UE would prefer not to perform the PSFCH transmission on resource 240C. Resource 240C on CC 214 may or may not overlap resource 2205 on CC 212 in the time domain. In this case, the assistant information may include the slot index of the PSFCH resource, i.e., the slot index for resource 240C. Alternatively, the assistant information may include the slot indexes of the PSSCH resources that are associated with the PSFCH resource 240C, that is, the slot indexes of resource 2305 and resource 2306.

Time duration 290 refers to a time duration for the UE to perform RF retuning from CC 212 to CC 213. During this period, the UE may not be able perform a transmission on resource 240B. The assistant information may include the slot index of the PSFCH resource, i.e., the slot index for resource 240B. Alternatively, the assistant information may include the slot indexes of the PSSCH resources that are associated with the PSFCH resource 240C, that is, the slot indexes of resource 2303 and resource 2304.

In response to receiving the assistant information for the UE (“UE #1” for clarity), a UE (“UE #2” for clarity) may schedule its sidelink transmissions to avoid the conflict. For example, in the case that the assistant information is related to the PSSCH resources, UE #2 may not perform sidelink transmissions on the indicated resources which would result in PSFCH transmissions that cannot be performed due to the Tx capability limitation of UE #1. For example, in the case that the assistant information is related to the PSFCH resource, UE #2 may not perform sidelink transmissions on resources which would result in PSFCH transmissions on the indicated resources.

In some embodiments, the UE may operate in resource allocation mode 1. When the UE is in resource allocation mode 1, the resource for sidelink transmission is granted by a BS. However, the PSFCH transmission for HARQ-ACK feedback and the PSFCH transmission for a resource conflict indicator depend on the received PSSCH transmissions from other UEs. Thus, the BS has no information regarding these PSFCH transmissions. Conflict may occur if these PSFCH transmissions are not taken into consideration. For example, the PSSCH transmissions granted by the BS or the PSFCH transmissions may not be performed by a UE due to the limited Tx capability of the UE.

To solve the above issues, a UE may transmit assistant information to a BS to assist the sidelink resource grant. For example, the assistant information may indicate the PSFCH transmissions on multiple carriers. In this way, the BS can schedule the sidelink transmissions to alleviate or avoid the exceeding of the Tx capability of the UE.

FIG. 3 illustrates an exemplary sidelink transmission according to some embodiments of the present disclosure.

In FIG. 3, a UE may be configured with a plurality of CCs, for example, CC 311, CC 312, CC 313, and CC 314. On CC 311, the UE may receive a PSSCH transmission with HARQ-ACK feedback enabled on resource 3301 and resource 3302, and perform the corresponding PSFCH transmission for HARQ-ACK feedback on resource 340A. On CC 312, the UE may receive a PSSCH transmission on resource 3303, which reserves another PSSCH transmission on resource 3304. In some examples, the UE may perform a PSFCH transmission (e.g., transmits the corresponding HARQ-ACK feedback) for the PSSCH transmission on resource 3304 on resource 340B. In some examples, the UE may perform a PSFCH transmission (e.g., transmits the corresponding HARQ-ACK feedback) for the another PSSCH transmission on resource 340B. On CC 313, the UE may receive a PSSCH transmission on resource 3305, which reserves another PSSCH transmission on resource 3306 and is associated with a PSFCH transmission for a resource conflict indicator on resource 340C. In some examples, the UE may detect a conflict associated with the PSSCH transmission on resource 3306, and may perform the PSFCH transmission for a resource conflict indicator on resource 340C. On CC 314, the UE may receive a PSSCH transmission on resource 3307, which reserves another PSSCH transmission on resource 3308. The PSSCH transmission on resource 3308 may be associated with a PSFCH transmission for a resource conflict indicator on resource 340D. In some examples, the UE may detect a conflict associated with the PSSCH transmission on resource 3308, and may perform the PSFCH transmission for a resource conflict indicator on resource 340D.

The assistant information regarding at least one of the following three types of PSFCH transmissions may be transmitted to the BS:
a) Type 1: a PSFCH transmission associated with a received transmission (e.g., a PSSCH transmission), and HARQ-ACK feedback is enabled for the received transmission, for example, the PSFCH transmission on resource 340A;
b) Type 2: a PSFCH transmission associated with a reserved transmission (e.g., a reserved PSSCH transmission), for example, the PSFCH transmission on resource 340B; or
c) Type 3: a PSFCH transmission for a resource conflict indicator, for example, the PSFCH transmission on resource 340C and the PSFCH transmission on resource 340D.

Regarding the type 1 PSFCH transmission, when the UE determines a PSFCH transmission for a PSFCH transmission with enabled HARQ-ACK feedback, the UE may transmit assistant information indicating such PSFCH transmission to the BS.

Regarding the type 2 PSFCH transmission, two cases may be considered.

Case A1: the reserved PSSCH transmission (e.g., PSSCH reserved on resource 3304) and the PSSCH transmission with a reservation signal (e.g., PSSCH on resource 3303) carry the same transport block (TB).

In the case that the transmission with a reservation signal (e.g., PSSCH transmission on resource 3303) is HARQ-ACK feedback enabled, the UE may assume that the HARQ-ACK feedback is also enabled for the reserved transmission. The UE may transmit assistant information indicating the PSFCH transmission associated with the reserved transmission (e.g., the PSFCH transmission on resource 340B) to the BS.

Case A2: the reserved transmission (e.g., the PSSCH transmission reserved on resource 3304) and the transmission with a reservation signal (e.g., the PSSCH transmission on resource 3303) carry different TBs.

In this case, the UE may assume that it should perform HARQ-ACK feedback if the HARQ-ACK feedback is enabled for the transmission (e.g., the PSSCH transmission on resource 3303) which reserves this reserved transmission (e.g., the PSSCH transmission reserved on resource 3304). The UE may determine the PSFCH associated with the reserved transmission as a potential PSFCH transmission. The UE may transmit assistant information indicating the potential PSFCH transmission (e.g., the PSFCH transmission on resource 340B) to the BS.

If the transmission which reserves this reserved transmission is HARQ-ACK feedback disabled, the UE may assume that no PSFCH will be transmitted for the reserved transmission. Accordingly, assistant information regarding the non-exist PSFCH transmission is not transmit to the BS.

Regarding the type 3 PSFCH transmission, two cases may be considered.

Case B1: in the case that the UE has detected a resource conflict associated with a PSSCH transmission (e.g., via a resource conflict detection procedure as specified in 3GPP specification), the UE may transmit assistant information indicating a PSFCH transmission for the resource conflict to the BS.

Case B2: in the case that the UE has not yet detected a resource conflict, the UE may determine whether a potential resource conflict may occur based on, for example, the channel busy ratio (CBR) measurement. For example, the UE may determine that a potential resource conflict of a PSSCH transmission may occur based on the CBR measurement associated with the PSSCH transmission, and may transmit assistant information indicating a PSFCH transmission for the potential resource conflict to the BS. In some examples, when the CBR measurement is higher than a threshold, the UE may determine a PSFCH transmission for a resource conflict indicator as a potential transmission, and the UE may transmit assistant information indicating the potential PSFCH transmission to the BS. The threshold may be pre-configured, predefined, indicated by the BS or by the network, etc.

The assistant information may include the slot index of the PSFCH resource, such as the slot index of resource 340A, 340B, 340C, or 340D in FIG. 3.

In response to receiving the assistant information on the PSFCH transmission from the UE, the BS may avoid scheduling the sidelink transmission on a carrier(s) under the assumption that such scheduled transmission may not be supported by the Tx capability of the UE.

In some embodiments, a UE may perform a resource selection procedure to select and/or reserve a resource(s) for sidelink transmission. The resource selection may be triggered at a certain time (e.g., time n), and the UE may determine a set of resources to be reported to higher layers and reserved for PSSCH transmission. The UE may perform sensing in a sensing window, and process information sensed in the sensing window to determine which resource(s) is (are) selectable.

During the resource selection, the UE may exclude a resource on a carrier when the UE cannot perform a transmission on the resource based on the Tx capability of the UE. For example, the UE cannot support a simultaneous transmission of a transmission on the excluded resource and a PSSCH transmission on a selected or reserved resource or PSFCH transmission on another carrier due to its limitation on Tx capability. For instance, the excluded resource may at least partially overlap another resource for PSCCH transmission or PSSCH transmission on another carrier that has already been selected or reserved, or at least partially overlap another resource for PSFCH transmission on another carrier. For instance, the UE does not support the carrier combination of the carrier of the excluded resource and the carrier of a selected or reserved resource for a PSSCH transmission or a resource for PSFCH transmission. For instance, the UE cannot transmit on the excluded resource due to a RF retuning time. For example, the excluded resource for a transmission may result in a PSSCH transmission on selected resource or reserved resource or a PSFCH transmission on another carrier located in the interruption of RF retuning time. In some cases, the PSFCH transmission may be a possible PSFCH transmission.

The possible PSFCH transmission may include a PSFCH transmission for HARQ-ACK feedback or a PSFCH transmission for a resource conflict indicator. For example, the possible PSFCH transmission may include the following three types of PSFCH transmissions. The detailed resource selection procedure regarding the three types of PSFCH transmissions are also presented below.

Type #1: a PSFCH transmission associated with a received transmission and HARQ-ACK feedback is enabled for the received transmission, for example, the PSFCH transmission on resource 340A on CC 311 in FIG. 3.

It is assumed that the UE has selected some resources for sidelink transmission with HARQ-ACK feedback enabled on another CC, each sidelink transmission is associated with a priority level, and the highest priority level among the priority levels is x1. It is further assumed that the highest priority level of one or more PSSCHs received by the UE with HARQ-ACK feedback to be transmitted in the same PSFCH occasion is y1. Based on the relation of the priority levels, the UE may take the following options:
1) Option A1: x1>y1, the UE may not determine the PSFCH transmission carrying the HARQ-ACK feedback for the one or more received PSSCHs as a possible PSFCH transmission;
2) Option A2: x1<y1, the UE may determine the PSFCH transmission carrying the HARQ-ACK feedback for the one or more received PSSCHs as a possible PSFCH transmission; and
3) Option A3: x1=y1, the UE may or may not determine the PSFCH transmission carrying the HARQ-ACK feedback for the one or more received PSSCHs as a possible PSFCH transmission. That is, it is up to UE implementation.

Type #2: a PSFCH transmission associated with a reserved transmission, for example, the PSFCH transmission on resource 340B in FIG. 3. Two cases may be considered.
Case C1: the reserved transmission (e.g., PSSCH reserved on resource 3304) and the transmission with a reservation signal (e.g., PSSCH on resource 3303) carry the same TB. In the case that the transmission with a reservation signal (e.g., PSSCH on resource 3303) indicates that the HARQ-ACK feedback is enabled, the UE may assume that the HARQ-ACK feedback is also enabled for the reserved transmission (e.g., PSSCH reserved on resource 3304).

It is assumed that the UE has selected some resources for sidelink transmission with HARQ-ACK feedback on another CC, each sidelink transmission is associated with a priority level, and the highest priority level among the priority levels is x2. It is further assumed that the highest priority level of one or more reserved PSSCHs with HARQ-ACK feedback to be transmitted in the same PSFCH occasion is y2. Based on the relation of the priority levels, the UE may take the following options:
1) Option B1: x2>y2, the UE may not determine the PSFCH transmission carrying the HARQ-ACK feedback for the one or more reserved PSSCHs as a possible PSFCH transmission;
2) Option B2: x2<y2, the UE may determine the PSFCH transmission carrying the HARQ-ACK feedback for the one or more reserved PSSCHs as a possible PSFCH transmission; and
3) Option B3: x2=y2, the UE may or may not determine the PSFCH transmission carrying the HARQ-ACK feedback for the one or more reserved PSSCHs as a possible PSFCH transmission. That is, it is up to UE implementation.

Case C2: the reserved transmission and the transmission with a reservation signal carry different TBs, that is, the reserved transmission is for another TB. The UE may assume that the UE may transmit HARQ-ACK feedback for the reserved transmission if the HARQ-ACK feedback is enabled for the transmission which reserves this reserved transmission. Otherwise, if the HARQ-ACK feedback is disabled for the transmission which reserves this reserved transmission, the UE may determine that the HARQ-ACK feedback is also disabled for this reserved transmission. That is, no PSFCH will be transmitted for the reserved transmission.

It is assumed that the UE has selected some resources for sidelink transmission with HARQ-ACK feedback on another CC, each sidelink transmission is associated with a priority level, and the highest priority level among the priority levels is x3. It is further assumed that one or more reserved PSSCHs is supposed to feedback corresponding HARQ-ACK information on the same PSFCH, and the highest priority level of the one or more reserved PSSCHs is y3. Based on the relation of the priority levels, the UE may take the following options:
1) Option C1: x3>y3, the UE may not determine the PSFCH transmission carrying the HARQ-ACK feedback for the one or more reserved PSSCHs as a possible PSFCH transmission;
2) Option C2: x3<y3, the UE may determine the PSFCH transmission carrying the HARQ-ACK feedback for the one or more reserved PSSCHs as a possible PSFCH transmission;
3) Option C3: x3=y3, the UE may or may not determine the PSFCH transmission carrying the HARQ-ACK feedback for the one or more reserved PSSCHs as a possible PSFCH transmission. That is, it is up to UE implementation.

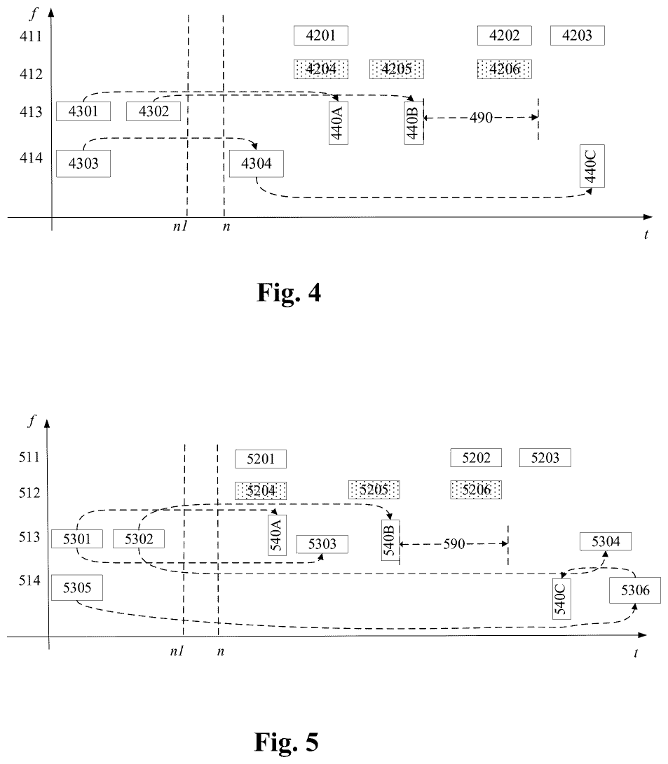

FIG. 4 illustrates an exemplary sidelink transmission according to some embodiments of the present disclosure.

In FIG. 4, a UE may be configured with a plurality of CCs, for example, CC 411, CC 412, CC 413, and CC 414 in a frequency domain. CC 411 may include resource 4201, resource 4202, and resource 4203. On CC 412, resource 4204, resource 4205, and resource 4206 are selected by the UE. On CC 413, the UE may receive a PSSCH transmission on resource 4301, which may be associated with a PSFCH transmission on resource 440A. For example, the UE may perform a PSFCH transmission (e.g., transmits the corresponding HARQ-ACK feedback) on resource 440A for the PSSCH transmission on resource 4301. The UE may receive a PSSCH transmission on resource 4302 on CC 413, which may be associated with a PSFCH transmission on resource 440B. On CC 414, the UE may receive PSSCH transmission on resource 4303, which reserves another PSSCH transmission on resource 4304. The another PSSCH transmission may be associated with a PSFCH transmission on resource 440C. The time interval 490 shows a RF retuning time required for switching from CC 413 to CC 411. During the period from n1 to n, the UE may process the information sensed in a sensing window, and at time n, the resource selection may be triggered.

It is assumed that the UE has selected resource 4204, resource 4205, and resource 4206 on CC 412, and may perform resource selection on other CCs. In some examples, the Tx capability of the UE may include: 1) simultaneous transmissions on a maximum of 2 carriers; 2) a carrier combination of CC 411 and CC 414 is not supported; and 3) an interruption for RF retuning time, e.g., the time interval 490.

The UE may exclude resource 4201 from its candidate resource set because the UE has selected resource 4204 on CC 412, and has received PSSCH transmission with HARQ-ACK feedback enabled on resource 4301 and may transmit the associated PSFCH transmission on resource 440A on CC 413. That is, since the UE is only capable of performing simultaneous transmissions on a maximum of 2 carriers in this example, and transmissions on resource 4204 and resource 440A has reached the maximum of 2 carriers, resource 4201 is excluded.

To transmit on CC 411, the UE may need to perform RF retuning from CC 413 to CC 411 after performing the PSFCH transmission on resource 440B. However, according to the time interval 490, there is not enough time for the UE to retune to CC 411 before the start of resource 4202. Therefore, the UE may exclude resource 4202.

As stated above, the UE has received a PSSCH transmission on resource 4303, which reserves a PSSCH transmission on resource 4304, and the UE may transmit the corresponding PSFCH transmission on 440C on CC 414. Since the UE does not support the carrier combination of CC 411 and CC 414, the UE may exclude resource 4203.

Type #3: a PSFCH transmission for a resource conflict indicator, which may include a PSFCH transmission associated with a transmission indicating a reserved resource (e.g., the PSFCH transmission on resource 340C in FIG. 3), and may include a PSFCH transmission associated with a reserved resource (e.g., the PSFCH transmission on resource 340D in FIG. 3).

Whether a UE performs a type #3 PSFCH transmission may depend on the resource conflict detection or a CBR measurement. For example, when the UE detects a resource conflict before a certain time (e.g., time n1), the UE may perform a PSFCH transmission for a resource conflict indicator. That is, the UE may determine the PSFCH transmission as a possible PSFCH transmission.

When the UE does not detect a resource conflict before the time n1, the UE may determine whether to perform the PSFCH transmission based on a CBR measurement. For example, when the CBR measurement is higher than a threshold value, the UE may determine the PSFCH for a resource conflict indicator as a possible PSFCH transmission. The threshold may be pre-configured, predefined, indicated by the BS or by the network, etc.

FIG. 5 illustrates an exemplary sidelink transmission according to some embodiments of the present disclosure.

In FIG. 5, a UE may be configured with a plurality of CCs, for example, CC 511, CC 512, CC 513, and CC 514. CC 511 may include resource 5201, resource 5202, and resource 5203. On CC 512, resource 5204, resource 5205, and resource 5206 are selected by the UE. On CC 513, the UE may receive a PSSCH transmission on resource 5301, which reserves a PSSCH transmission on resource 5303. PSSCH transmission on resource 5301 may be associated with a PSFCH transmission on resource 540A. For example, the UE may transmit the corresponding HARQ-ACK feedback on resource 540A for the PSSCH transmission on resource 5301. The UE may receive PSSCH transmission on resource 5302, which reserves a PSSCH transmission on resource 5304. PSSCH transmission on resource 5302 may be associated with a PSFCH transmission on resource 540B. For example, the UE may transmit a PSFCH transmission for a resource conflict indicator on resource 540B for the PSSCH transmission on resource 5304.

On CC 514, the UE may receive a PSSCH transmission on resource 5305, which reserves another PSSCH transmission on resource 5306, and the UE may perform a corresponding PSFCH transmission on resource 540C. During the time interval 590, the UE may perform RF retuning from CC 513 to CC 511. During the period from n1 to n, the UE may process the information sensed in a sensing window, and at time n, the resource selection may be triggered.

It is assumed that UE has selected resource 5204, resource 5205, and resource 5206 on CC 512, and may perform resource selection on other CCs. In some examples, the Tx capability of the UE may include: 1) simultaneous transmissions on a maximum of 2 carriers; 2) a carrier combination of CC 511 and CC 514 is not supported; and 3) an interruption for RF retuning time, e.g., the time interval 590.

The UE may exclude resource 5201 from its candidate resource set, because the UE has selected resource 5204 on CC 512, and the UE has received a PSSCH transmission with HARQ-ACK feedback enabled on resource 5301, and may transmit the associated PSFCH transmission on resource 540A on CC 513. That is, since the UE is only capable of performing simultaneous transmissions on a maximum of 2 carriers in this example, and transmission on resource 5204 and resource 540A has reached the maximum of 2 carriers, resource 5201 is excluded.

In the case that the UE detects a resource conflict relating to the reserved resource 5304, which is used for PSSCH transmission, the UE may perform a PSFCH transmission on resource 540B on CC 513. However, according to the time interval 590, the UE may exclude 5202 because there is not enough time for the UE to retune to CC 511 before the start of resource #5202.

As stated above, the UE has received a PSSCH transmission on resource 5305, which reserves the PSSCH transmission on resource 5306, and the UE may transmit the corresponding PSFCH transmission on 540C on CC 514. Since the UE does not support the carrier combination of CC 511 and CC 514, the UE may exclude resource 5203.

In some embodiments, the UE may further evaluate a possible PSFCH transmission based on the priority levels. It is assumed that the UE selects some resources on a carrier (“carrier #A1” for clarity), and the highest priority level among the transmissions on carrier #A1 is A4. It is further assumed that the highest priority level associated with a PSFCH transmission on another carrier (“carrier #A2” for clarity) is B4. In some examples, when A4>B4, the UE may not consider the PSFCH transmission on carrier #A2 as a possible PSFCH transmission. For example, the UE may not perform the PSFCH transmission on carrier #A2.

In some embodiments, a priority threshold (“threshold #1” for clarity) may be configured for a PSFCH transmission. When B4 is lower than threshold #1, the UE may not consider the PSFCH transmission on carrier #A2 as a possible PSFCH transmission. For example, the UE may not perform the PSFCH transmission on carrier #A2. In some embodiments, a priority threshold (“threshold #2” for clarity) may be configured for transmissions on selected resources (e.g., the transmissions on carrier #A1). When A4 is higher than threshold #2, the UE may not consider the PSFCH transmission on carrier #A2 as a possible PSFCH transmission. For example, the UE may not perform the PSFCH transmission on carrier #A2.

In some embodiments, the UE may further evaluate a possible PSFCH transmissions based on the channel types. For example, a PSFCH transmission for HARQ-ACK feedback may have a relatively higher priority level. When the PSFCH transmission on carrier #A2 carries a resource conflict indicator, the UE may not consider the PSFCH transmission on carrier #A2 as a possible PSFCH transmission. When the PSFCH transmission on carrier #A2 carries the HARQ-ACK feedback, the UE may consider the PSFCH transmission on carrier #A2 as a possible PSFCH transmission. The UE may perform the PSFCH transmission on carrier #A2.

In some embodiments, the UE may select a set of transmissions which will not exceed its Tx capability in the case that multiple PSSCHs and PSFCH transmissions on multiple carriers will exceed the Tx capability of the UE.

The present disclosure proposes some solutions for selecting the transmissions as follows:

Solution 1: the UE may select the transmissions based on different prioritization order of different channel types (e.g., PSSCH, PSFCH for HARQ-ACK feedback, PSFCH for a resource conflict indicator). For example, the priority level of the channel types may be: a PSFCH transmission for HARQ-ACK feedback>a PSSCH transmission>a PSFCH transmission for a resource conflict indicator. Transmissions of the same channel type may be further prioritized based on the priories of these transmissions of the same channel type.

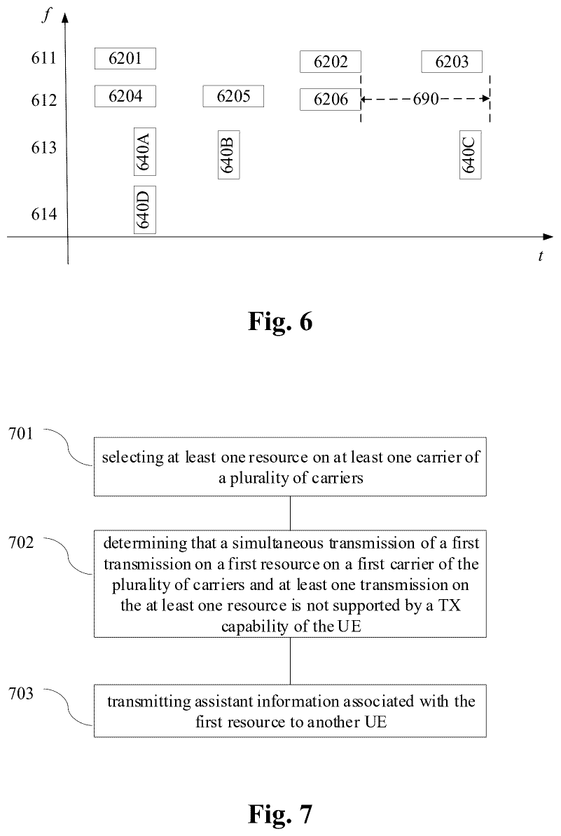

FIG. 6 illustrates an exemplary sidelink transmission according to some embodiments of the present disclosure.

In FIG. 6, a UE may be configured with a plurality of CCs, for example, CCs, CC 611, CC 612, CC 613, and CC 614. CC 611 may include resource 6201, resource 6202, and resource 6203. CC 612 may include resource 6204, resource 6205, and resource 6206. On CC 613, the UE may perform a PSFCH transmission for HARQ-ACK feedback on resource 640A, a PSFCH transmission for HARQ-ACK feedback resource 640B, and a PSFCH transmission for HARQ-ACK feedback resource 640C. On CC 614, the UE may perform a PSFCH transmission for a resource conflict indicator on resource 640D. In some examples, the Tx capability of the UE may include: 1) simultaneous transmissions on maximum 2 carriers; 2) a carrier combination of CC 612 and CC 613 is not supported; and 3) an interruption for RF retuning time, i.e. the time interval 690.

Performing the transmission on resource 6201, resource 6204, resource 640A, and resource 640D simultaneously may not be supported by the Tx capability of the UE when, for example, the UE can only perform transmission on the maximum of 2 carriers. The UE may select transmissions on two carriers. Since the PSFCH transmission on resource 640A is for HARQ-ACK feedback and the PSFCH transmission on resource 640D is for a resource conflict indicator, thus the PSFCH transmission on resource 640A may be selected since the priority level of a PSFCH transmission for HARQ-ACK feedback is higher than those of a PSSCH transmission and a PSFCH transmission for a resource conflict indicator. The PSFCH transmission on resource 640D may be dropped. Assuming that the priority level of PSSCH transmission on resource 6201 is higher than that on resource 6204, PSSCH transmission on resource 6201 may be performed and PSSCH transmission on resource 6204 may be dropped.

Since the carrier combination of CC 612 and CC 613 is not supported, the UE may select one transmission between the PSSCH transmission on resource 6205 and the PSFCH transmission on resource 640B. Since the PSFCH transmission on resource 640B is for HARQ-ACK feedback, the PSFCH transmission on resource 640B may be selected and the PSSCH transmission on resource 6205 may be dropped. In the case that the PSFCH transmission on resource 640B is for a resource conflict indicator, then the PSFCH transmission on resource 640B may be dropped and the PSSCH transmission on resource 6205 may be selected.

Due to the RF retuning time, the UE may select one transmission between PSSCH transmission on resource 6206 on CC 612 and PSFCH transmission on resource 640C on CC 613. The prioritization order may be applied for the selection. Since PSFCH transmission on resource 640C is for HARQ-ACK feedback, then PSFCH transmission on resource 640C may be selected, and the PSSCH transmission on resource 6206 may be dropped.

Solution 2: the UE may select the transmissions based on a common prioritization order of different channel types. For example, the UE may not first prioritize the transmissions based on the channel types, and may select the transmissions based on the priories of these transmissions. In the context of the disclosure, one or more priority levels may be associated with a PSFCH transmission. For example, the PSFCH transmission may carry HARQ-ACK feedback for one or more PSSCHs, which may correspond to one or more priority levels. The highest priority level among the one or more priority levels may be deemed as the priority level of the PSFCH transmission.

Referring again to FIG. 6, performing the transmissions on resource 6201, resource 6204, resource 640A, and resource 640D simultaneously may not be supported by the Tx capability of the UE. The UE may select transmissions on two carriers according to the priority level. For example, the UE may select PSFCH transmissions on resources 640A and 640D since they have the two highest priorities among those of transmissions on resource 6201, resource 6204, resource 640A, and resource 640D.

Since the carrier combination of CC 612 and CC 613 is not supported, the UE may select one transmission between the PSSCH transmission on resource 6205 on CC 612 and the PSFCH transmission on resource 640B on CC 613. If the PSFCH transmission on resource 640B is associated with multiple priority levels, the UE may make the selection based on the highest priority level among the multiple priority levels and the priority level of the PSSCH transmission on resource 6205.

Due to the RF retuning time, the UE may select one transmission between the PSSCH transmission on resource 6206 on CC 612 and the PSFCH transmission on resource 640C on CC 613. The UE may select one transmission between the PSSCH transmission and the PSFCH transmission based on the associated priority levels. If PSFCH transmission is associated with multiple priority levels, the highest priority level is used during the selection.

FIG. 7 illustrates an exemplary method performed by a UE for wireless communication according to a preferred embodiment of the present disclosure. Details described in all of the foregoing embodiments of the present disclosure are applicable for the embodiments shown in FIG. 7. In some examples, the procedure may be performed by a UE, for example, UE 101-A.

In operation 701, the UE may select at least one resource on at least one carrier of a plurality of carriers. In operation 702, the UE may determine that a simultaneous transmission of a first transmission on a first resource on a first carrier of the plurality of carriers and at least one transmission on the at least one resource is not supported by a Tx capability of the UE. The first carrier may be different from the at least one carrier. In operation 703, the UE may transmit assistant information associated with the first resource to another UE. For example, referring to FIG. 2, the UE may transmit assistant information including the slot index for resource 240C to another UE.

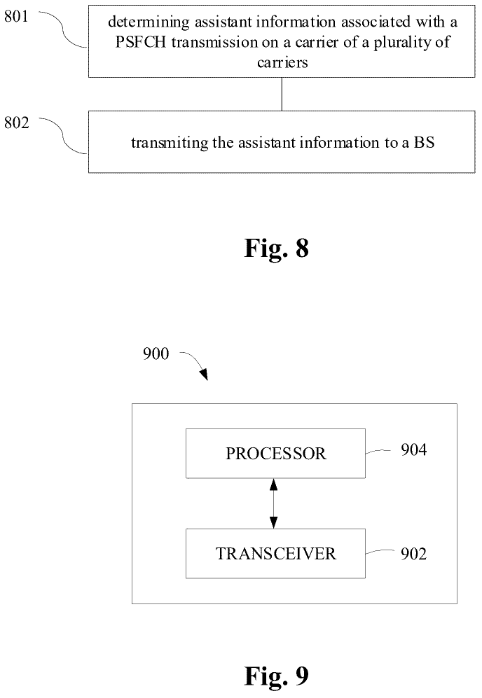

FIG. 8 illustrates an exemplary method performed by a UE for wireless communication according to a preferred embodiment of the present disclosure. Details described in all of the foregoing embodiments of the present disclosure are applicable for the embodiments shown in FIG. 8. In some examples, the procedure may be performed by a UE, for example, UE 101-A in FIG. 1.

In operation 801, the UE may determine assistant information associated with a PSFCH transmission on a carrier of a plurality of carriers. In operation 802, the UE may transmit the assistant information to a BS. For example, referring to FIG. 2, the UE may transmit assistant information including the slot indexes of the resource for PSFCH transmissions, such as the slot index of resource 340A, 340B, 340C, or 340D.

FIG. 9 illustrates an exemplary simplified block diagram of an exemplary apparatus according to some embodiments of the present disclosure. As shown in FIG. 9, the apparatus 900 may include at least one processor 904 and at least one transceiver 902 coupled to the processor 904. The apparatus 900 may be a UE or a BS.

Although in this figure, elements such as the at least one transceiver 902 and processor 904 are described in the singular, the plural is contemplated unless a limitation to the singular is explicitly stated. In some embodiments of the present disclosure, the transceiver 902 may be divided into two devices, such as a receiving circuitry and a transmitting circuitry. In some embodiments of the present disclosure, the apparatus 900 may further include an input device, a memory, and/or other components.

In some embodiments of the present disclosure, the apparatus 900 may be a UE. The transceiver 902 and the processor 904 may interact with each other so as to perform the operations with respect to the UE described in FIGS. 1-8. In some embodiments of the present disclosure, the apparatus 900 may be a BS. The transceiver 902 and the processor 904 may interact with each other so as to perform the operations with respect to the BS described in FIGS. 1-8.

In some embodiments of the present disclosure, the apparatus 900 may further include at least one non-transitory computer-readable medium.

For example, in some embodiments of the present disclosure, the non-transitory computer-readable medium may have stored thereon computer-executable instructions to cause the processor 904 to implement the method with respect to the UE as described above. For example, the computer-executable instructions, when executed, cause the processor 904 interacting with transceiver 902 to perform the operations with respect to the UE described in FIGS. 1-8.

In some embodiments of the present disclosure, the non-transitory computer-readable medium may have stored thereon computer-executable instructions to cause the processor 904 to implement the method with respect to the BS as described above. For example, the computer-executable instructions, when executed, cause the processor 904 interacting with transceiver 902 to perform the operations with respect to the BS described in FIGS. 1-8.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each FIG. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
select at least one resource on at least one carrier of a plurality of carriers;
determine that a simultaneous transmission of a first transmission on a first resource on a first carrier of the plurality of carriers and at least one transmission on the at least one resource is not supported by a transmit capability of the UE, wherein the first carrier is different from the at least one carrier; and
transmit assistant information associated with the first resource to another UE.

2. The UE of claim 1, wherein the first transmission includes a physical sidelink feedback channel (PSFCH) transmission that at least partially overlaps with the at least one resource in a time domain, or at least partially overlaps with a radio frequency (RF) retuning period from a carrier of the at least one carrier to the first carrier.

3. The UE of claim 1, wherein a carrier combination of the first carrier and the at least one carrier is not supported by the transmit capability of the UE.

4. The UE of claim 1, wherein the first resource is for a physical sidelink feedback channel (PSFCH) transmission.

5. The UE of claim 1, wherein the assistant information indicates a slot index of the first resource.

6. The UE of claim 4, wherein the assistant information indicates a slot index of a physical sidelink share channel (PSSCH) reception associated with the PSFCH transmission on the first resource.

7. The UE of claim 1, wherein the transmit capability of the UE comprises at least one of: a limited number of simultaneous transmission carriers, a limitation on supported carrier combinations, or an interruption for radio frequency (RF) retuning.

8. A user equipment (UE) for wireless communication, comprising:
at least one memory; and
at least one processor coupled with the at least one memory and configured to cause the UE to:
determine assistant information associated with a physical sidelink feedback channel (PSFCH) transmission on a carrier of a plurality of carriers; and
transmit the assistant information to a base station (BS).

9. The UE of claim 8, wherein the PSFCH transmission includes at least one of:
a PSFCH transmission associated with a physical sidelink share channel (PSSCH) reception with enabled hybrid automatic repeat request acknowledgement (HARQ-ACK);
a PSFCH transmission associated with a reserved PSSCH reception; or
a PSFCH transmission associated with a resource conflict indicator.

10. The UE of claim 9, wherein the reserved PSSCH reception is reserved by a PSSCH reception with an enabled HARQ-ACK.

11. The UE of claim 9, wherein the PSFCH transmission associated with a resource conflict indicator indicates a resource conflict of a PSSCH transmission.

12. The UE of claim 9, wherein the PSFCH transmission associated with a resource conflict indicator indicates a potential resource conflict of a PSSCH transmission based on a channel busy ratio (CBR) measurement associated with the PSSCH transmission.

13. (canceled)

14. (canceled)

15. (canceled)

16. A processor for wireless communication, comprising:
at least one controller coupled with at least one memory and configured to cause the processor to:
select at least one resource on at least one carrier of a plurality of carriers;
determine that a simultaneous transmission of a first transmission on a first resource on a first carrier of the plurality of carriers and at least one transmission on the at least one resource is not supported by a transmit capability of the processor, wherein the first carrier is different from the at least one carrier; and
transmit assistant information associated with the first resource to another user equipment (UE).

17. The processor of claim 16, wherein the first transmission includes a physical sidelink feedback channel (PSFCH) transmission that at least partially overlaps with the at least one resource in a time domain, or at least partially overlaps with a radio frequency (RF) retuning period from a carrier of the at least one carrier to the first carrier.

18. The processor of claim 16, wherein a carrier combination of the first carrier and the at least one carrier is not supported by the transmit capability of the processor.

19. The processor of claim 16, wherein the first resource is for a physical sidelink feedback channel (PSFCH) transmission.

20. The processor of claim 16, wherein the assistant information indicates a slot index of the first resource.

21. The processor of claim 19, wherein the assistant information indicates a slot index of a physical sidelink share channel (PSSCH) reception associated with the PSFCH transmission on the first resource.

22. The processor of claim 16, wherein the transmit capability of the processor comprises at least one of: a limited number of simultaneous transmission carriers, a limitation on supported carrier combinations, or an interruption for radio frequency (RF) retuning.

23. A processor for wireless communication, comprising:
at least one controller coupled with at least one memory and configured to cause the processor to:
determine assistant information associated with a physical sidelink feedback channel (PSFCH) transmission on a carrier of a plurality of carriers; and
transmit the assistant information to a base station (BS).
